(19) United States
(12) Patent Application Publication
(10) Pub. No.: US 2015/0344319 A1
(43) Pub. Date: Dec. 3, 2015

(54) Method for Producing Calcium Carbonate Gel and Product Obtained Thereby

(71) Applicant: S.A. LHOIST RECHERCHE ET DÉVELOPPEMENT, Ottignies-Louvain-La-Neuve (BE)

(72) Inventors: Geert Jan Witkamp, Bergschenhoek (NL); Sergio Andres Perez Escobar, Delft (NL); Robert Sebastian Gaertner, Buizingen (BE)

(21) Appl. No.: 14/761,108

(22) PCT Filed: Jan. 30, 2014
(86) PCT No.: PCT/EP14/51808

§ 371 Date: Jul. 15, 2015

Related U.S. Application Data
(60) Provisional application No. 61/829,629, filed on May 31, 2013.

(30) Foreign Application Priority Data
Jan. 30, 2013 (BE) 2013/0063

(51) Int. Cl. C01F 11/18

(52) U.S. Cl. CPC C01F 11/18; C01F 11/184; C01P 2004/50; C01P 2004/64; C01P 2004/62; C01P 2006/12

(57) ABSTRACT

A method for preparing a calcium carbonate gel, comprising a reaction between slaked lime in solid, dry from, and of alcohol so as to form an alcoholic suspension of calcium alcoholate, an injection of carbon dioxide into said suspension, and gelling of the suspension as a precipitated calcium carbonate alcogel, this alcogel then being able to be dried into an aerogel or xerogel of calcium carbonate.

The present invention relates to a method for preparing a calcium carbonate gel and to the products obtained by means of such a method.

The preparation of calcium carbonate gels is known from a reaction between quick lime (CaO) and absolute methanol (without any water), with formation of a methanolate followed by injection of CO₂, in order to obtain a calcium dimethyl carbonate, which by reaction with water produces a calcium carbonate and methanol. Next, the obtained gel may be subject to drying with CO₂ so as to form an aerogel of calcium carbonate as an aggregated precipitate of vaterite particles of nanometric size in order to form a lattice of the aerogel type (see for example J. Plank at cons., Preparation and Characterization of a Calcium Carbonate Aerogel, Hindawi Publishing Corporation, Research Letters in Materials Science, 2009, Article ID 138476; A. Buzagh, Über kolloïde Lösungen der Erdalkalikarbonate, Kolloïd-Zeitschrift, 38, 3, p. 222-226, 1926; E. Berner, Über die Einwirkung der Erdalkalioxyde auf Alkohole, Berichte der deutschen chemischen Gesellschaft, 71, 9, p. 2015-2021, 1938). However, it has appeared that this production method was not very reliable, because it was not very reproducible. This lack of control on the properties and qualities of the obtained gel represents an unacceptable handicap, when the intention is to undertake production at an industrial scale, in particular of aerogels.

Other methods for preparing gels or aerogels based on calcium are known, such as for example those starting with calcium alginate (see for example R. Horga at cons., Ionotropic Alginates Aerogels as Precursors of Dispersed Oxide Phases, Applied Catalysis A, 325, 2, p. 251-255, 2007).

Document EP 0522415 teaches a method for producing calcium carbonate by carbonation of a calcium-based compound in monoethylene glycol followed by a step for ripening the dispersion (also see, M. Ryu et al., Synthesis of calcium carbonate in ethanol-ethylene glycol solvent, Journal of the Ceramic Society of Japan, 117[1] 106-110, 2009).

Gels and aerogels of silica have further been known for a long time. The reaction for forming a lattice of silica nanoparticles is however slow and requires the use of polycondensation catalysts for accelerating production on an industrial scale. These catalysts however have the effect of altering the quality of the gel and its reproducibility. The result of this is a high cost for silica aerogels.

The preparation of the majority of silica aerogels resorts to precursors of the tetramethyl or tetraethyl orthosilicate type, which are highly toxic compounds.

For the gels of the prior art, an additional ripening step in an alcohol/water solution and in the case of silica gels, a step for soaking in alcohol in order to extract the water are required. Indeed, any trace of water left in a silica gel will not be eliminated during drying by CO₂ and will lead to an opaque and very dense aerogel.

The gels of the prior art, in particular of silica, are hydrophilic and even hygroscopic by nature. Water absorption, notably from ambient air, leads to structural modifications, i.e. deterioration of the aerogel, which usually requires preliminary chemical treatments of hydrophobation.

The assumed reaction mechanism from the work of Plank et al. is the following:

a) Formation of a Methanolate Starting with Quick Lime

CaO+2MeOH→Ca(MeO)₂+H₂O

b) Carbonation into Dimethyl Carbonate

Ca(MeO)₂+2CO₂→Ca(CO₂MeO)₂

### c) Production in the Presence of Water of a Carbonate for Forming a Gel

Ca(CO₂MeO)₂+H₂O→CaCO₂+2MeOH+CO₂

The object of the present invention is to propose a method for preparing a gel which may be reliably controlled and thus give rise to industrially reproducible gels. This method should advantageously be simple and thus allow industrial production of stable aerogels notably, advantageously with a large BET specific surface area, which preferably are mechanically resistant.

In order to solve these problems, a method for preparing a calcium carbonate gel is provided according to the invention, comprising
a reaction between slaked lime in solid, dry form and alcohol so as to form an alcoholic suspension of calcium alcoholate,
injection of carbon dioxide into said suspension, and
gelling of the suspension as an alcogel of precipitated calcium carbonate.

An assumed reaction mechanism according to the invention is the following, in the case when the alcohol is methanol:

I) Formation of Methanolate Starting with Slaked Lime

Ca(O)₂+MeOH→Ca(OH)(MeO)+H₂O

II) Carbonation into Methylcarbonate Hydroxide

Ca(OH)(MeO)+CO₂→Ca(CO₂MeO)(OH)

### III) Production of a Carbonate for Forming a Gel

Ca(CO₂MeO)(OH)→CaCO₃+MeOH

The advantage of using slaked lime according to the present invention lies in the high reproducibility and excellent control of the quality of the reaction between this hydrated, solid, dry lime and alcohol. In this way, the solid material content, the specific surface area and the apparent specific gravity of the gels obtained may be perfectly controlled, which was not the case with quick lime used in the prior state of the art.

According to the invention, by slaked lime (Ca(OH)₂), should be meant a solid, dry composition which may only contain up to a few % by weight of free water. This cannot by any means be lime milk, since the water of such a suspension would contribute to destructuration of the gel during production. Preferably, the slaked lime applied is a powder having particles with a size of less than 1 mm, advantageously less than 500 μm, preferably less than 90 μm; most of the particles are greater than 0.5 μm.

It should be noted that this solid slaked lime composition which essentially comprises calcium hydroxide particles, may further include usual impurities of industrial lime, i.e. phases derived from SiO₂, Al₂O₃, Fe₂O₃, MnO, P₂O₅, K₂O and/or SO₃, globally in an amount of a few tens of grams per kilogram of slaked lime. Nevertheless, the sum of these impurities, expressed as the aforementioned oxides, will not exceed 5%, preferably 3%, in particular 2% or even 1% by weight of the solid composition of slaked lime.

The slaked lime according to the invention may also contain calcium oxide CaO which would not have been hydrated during slaking, or calcium carbonate CaCO₃ either from the initial limestone, from which the slaked lime is derived (unburnt portion), or from a partial carbonation reaction of slaked lime in contact with air. The calcium oxide content in the slaked lime according to the invention will not exceed 3% by weight. Preferably it will be less than 2%, advantageously less than 1% by weight of the solid slaked rime composition. The calcium carbonate content will be less than 10%, preferably less than 6%, in particular less than 4% and even advantageously less than 3% by weight of the slaked lime composition.

The slaked lime according to the invention may also contain magnesium oxide MgO or phases derived from the Mg(OH)₂ or MgCO₃ type. The sum of these impurities, expressed as MgO, will not exceed 5%, preferably 3%, in particular 2% or even advantageously 1% by weight of the slaked lime composition.

The nature of the alcohol applied according to the invention is not critical. Any alcohol known to one skilled in the art and giving the possibility of forming an alcogel with lime is therefore suitable. It should however be noted that it is desirable that the alcohol used contains the least water possible, since, as indicated above, this water would risk destructuring the gel. Moreover, it is desirable that the alcohol used has a relatively low boiling point, is not too viscous and has good solubility in supercritical CO₂.

Within the scope of the present invention, the monoalcohols, alcohols for which the formula has only one OH group, are therefore in particular preferred, those having a purity greater than or equal to 95% of technical grade, the residual 5% being typically in the form of impurities and/or water or also glycol trace amounts, like monoethylene glycol, which, as for it, is soluble with difficulty in supercritical CO₂.

Mention may also be made as examples of alcohols which may be used, of monoalcohols, methanol, ethanol, propanol, butanol and isopropanol, although, for the reasons stated above, the use of ethanol seems rather less favourable.

The proportion of slaked lime relatively to the alcohol is preferably from 15 g/dm³ to 200 g/dm³, in particular from 15 g/dm³ to 100 g/dm³ (grams of slaked lime per dm³ of alcohol).

The reaction between slaked lime and the alcohol is only moderately exothermic and rather slow. Slight heating of the reactor may therefore be provided, in which the reaction should occur for example at a temperature comprised between 20 and 70° C., preferably 30 and 70° C.

This reaction may last for about 1 to 2 hours. Advantageously, the obtained suspension may then, before the injection step, be sieved through a sieve having a mesh aperture comprised between 20 and 250 μm, in particular equal to or less than 45 μm.

The injection of carbon dioxide into said suspension preferably takes place at a temperature comprised between 30° C. and 70° C. It has the purpose of generating an alkyl carbonate in the alcoholic suspension of calcium alcoholate. It is advantageously stopped when this suspension has a pH of less than 9, in particular less than 8.7 and advantageously less than 8.3.

As an injection gas, it is possible to use, in addition to carbon dioxide, any gas mixture containing CO₂ and at least one other gas, for example air.

After the injection, sieving of the saturated suspension may advantageously be provided through a sieve having a mesh aperture comprised between 20 and 250 μm, in particular equal to or less than 45 μm.

After the injection, the alcoholic suspension of calcium alkyl carbonate (notably methyl carbonate) is left to gel with formation of an alcogel of precipitated calcium carbonate.

According to a preferential embodiment of the invention, the method further comprises after the injection and/or the beginning of the latter, seeding of the alcoholic calcium alcoholate suspension with calcium carbonate crystals. As calcium carbonate crystals, it is in particular possible to provide those selected from the group formed by calcite, aragonite, vaterite crystals and mixtures thereof. The calcite or aragonite crystals are particularly preferential, since they give rise to very stable calcite gel.

According to a particular embodiment of the invention, the method further comprises, after the injection and/or at the beginning of the latter, an addition of at least one inhibitor of crystal growth of CaCO₃, notably sugar, to said alcoholic suspension. As inhibitors of crystal growth of CaCO₃, mention may be made inter alia of sucrose, saccharose, a monosaccharide, in particular glucose, fructose or galactose, a disaccharide, in particular lactose, maltose or sorbitol, citric acid, polyacrylates, soluble phosphates or metaphosphates or their corresponding acids or further soluble strontium or magnesium salts. Preferably, addition of an amount comprised between 500 ppm and 5% by weight based on the initial Ca(OH)₂ is provided.

According to a particularly advantageous embodiment of the invention, the method further comprises drying of the precipitated calcium carbonate alcogel, so as to form a calcium carbonate aerogel. This drying may be carried out according to any method known to one skilled in the art. For example, submitting the alcogel to a known treatment with liquid or supercritical CO₂ may for example be contemplated. Such a treatment is vaguely described for example in the article of J. Plank et al. mentioned above.

Other methods for gel drying produce what are called xerogels. Unlike drying by a supercritical fluid, a contraction of the gel cannot be avoided but is reduced. The most known methods are drying by freezing (freeze-drying) or cold drying. During freeze-drying, the solvent in the gel is frozen and slowly sublimated by applying vacuum or a very low partial pressure. In the case of methanol, temperatures below 175 K should then be applied. This method does not only have the disadvantage of requiring extremely low temperatures and long drying periods, but also solidification of the solvent may break the structure of the gel. The cold drying method consists of evaporating the solvent of the gel at a low temperature by applying a vacuum or a low partial pressure, conditions in which recrystallization of the particles is avoided. For gels of vaterite and calcite, the temperature should be below 278 K. While xerogels give the possibility of attaining high specific surface areas and small particle sizes, they are commonly denser than aerogels dried under supercritical conditions.

It appeared that a calcite gel obtained by seeding the alcoholic calcium alcoholate suspension with calcite or aragonite crystals gave rise after such drying to an aerogel much more resistant to degradation and to recrystallization. According to the seed crystals and their structure, the formed gel will have a preferred crystalline form, which will comprise a proportion of vaterite preferably less than 97% by weight. The crystallinity of the calcite gel may be controlled by two parameters, i.e., the amount of initial calcite and its fineness (size of the calcite particles).

The greater the amount of initial calcite, the higher is the seeding level, expressed by a greater amount of calcite in the obtained gel. As regards to the fineness of the calcite, the finer the latter, the higher the seeding level.

Unlike a vaterite aerogel, as described in the prior state of the art, a calcite aerogel has good stability in the presence of water, in particular of the humidity of the air.

A precipitated calcium carbonate gel in the presence of the addition of sugar is capable, after drying as provided above, to give rise to an aerogel with extremely high BET specific surface area and pore volume to nitrogen, which has a surprising mechanical strength.

By the terms <<BET specific surface area>> in the sense of the present invention, is meant the specific surface area measured by nitrogen adsorption manometry and calculated according to the BET method.

By the term <<particles>> in the sense of the present invention, is meant the smallest solid discontinuity of the mineral filling material observable by scanning electron microscopy (SEM).

The present invention also relates to the gels obtained by a method according to the invention.

The alcogel obtained after gelling advantageously consists of 1 to 6% by volume of precipitated calcium carbonate nanoparticles having a particle size substantially comprised between 5 and 600 nm, in particular between 5 and 300 nm, advantageously between 10 and 200 nm, preferably between 10 and 50 nm, more preferentially between 10 and 20 nm. This last interval is most particularly characteristic of vaterite precipitates. These nanoparticles are in fact agglomerates of calcium carbonate crystallites, the size of which is smaller than that of the nanoparticles.

The calcium carbonate aerogel or the calcium carbonate xerogel obtained according to the invention advantageously has a BET specific surface area from 4 to 450 m²/g, preferably from 5 to 450 m²/g.

Advantageously, the calcium carbonate aerogel according to the invention has a BET specific surface area comprised between 40 and 450 m²/g, preferably between 45 and 450 m²/g, more preferentially between 47 and 450 m²/g and advantageously between 50 and 450 m²/g, in particular from 100 to 450 m²/g.

According to a preferred embodiment of the present invention, the calcium carbonate xerogel according to the invention has a specific surface area comprised between 4 and 50 m²/g, preferably between 5 and 45 m²/g, more preferentially between 8 and 40 m²/g.

According to a preferred embodiment of the present invention, the calcium carbonate xerogel according to the invention has a crystallite size comprised between 20 and 100 nm, notably for calcite particles, in particular between 15 and 30 nm, notably for vaterite particles.

The calcium carbonate aerogel according to the invention as for it advantageously has a crystallite size comprised between 5 and 100 nm, notably for calcite particles, in particular between 5 and 30 nm, notably for vaterite particles, more particularly between 5 and 20 nm.

The calcium carbonate aerogel or the calcium carbonate xerogel obtained according to the invention advantageously has an apparent specific gravity comprised between 0.01 and 0.15 g/cm³, preferably between 0.02 and 0.06 g/cm³.

Advantageously, the aerogel or xerogel according to the invention is characterized in that it consists of an aerogel or xerogel of calcite, vaterite, aragonite, or mixtures thereof.

In a preferred embodiment of the present invention, the aerogel is characterized in that it has a BET specific surface area comprised between 4 and 40 m²/g, or between 100 and 250 m²/g, a crystallite size comprised between 5 and 30 nm notably for vaterite and a particle size comprised between 60 and 600 nm or between 5 and 20 nm.

Within the scope of the present invention, the particle sizes were calculated by optical microscopy. The thereby obtained average was retained for determining the ranges of values.

Within the scope of the present invention, the aerogel obtained according to the invention advantageously has a BET specific surface area comprised between 100 and 450 m²/g, a crystallite size comprised between 5 and 20 nm, notably for calcite and for vaterite, and a particle size of about 10 nm when it is obtained in the presence of a growth inhibitor.

In a particularly advantageous way, the xerogel according to the invention is characterized in that it has a BET specific surface area comprised between 4 and 10 m²/g, a crystallite size comprised between 20 and 100 nm, notably for calcite and between 15 and 30 nm, notably for vaterite and a particle size comprised between 100 and 500 nm.

According to a particularly preferred embodiment, the xerogel according to the invention is characterized in that it has a BET specific surface area comprised between 20 and 40 m²/g, a crystallite size comprised between 20 and 100 nm, notably for calcite and between 15 and 30 nm, notably for vaterite and a particle size comprised between 50 and 150 nm.

It will be noted that during the production of a calcium carbonate gel and aerogel according to the invention, the decomposition of the calcium alkyl carbonate (notably methyl carbonate) hydroxide into calcium carbonate (step III) does not require any water, unlike in the prior art (step c.) but just depends on the concentration of this compound. Accordingly, the method according to the invention does not require steps for ripening and soaking the gel as in the case of the prior art.

Further, the thereby obtained aerogel according to the present invention has thermal and/or acoustic conductivity properties (22.2 mW/m/K for a packed density of 150 g/dm³), which makes this product inter alia an interesting candidate as an insulator.

Other details and particularities of the invention will become apparent from the description given below of non-limiting exemplary embodiments.

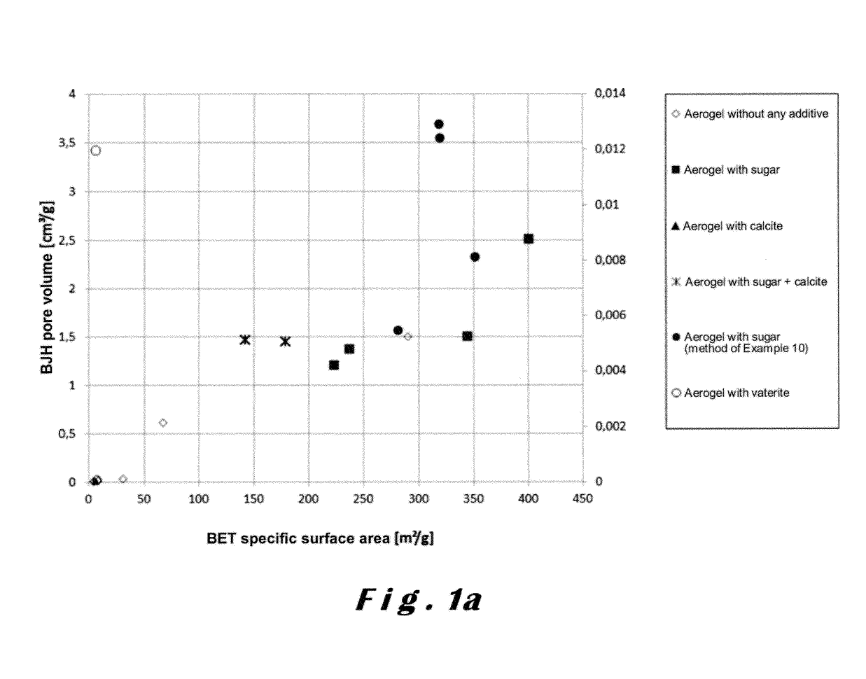

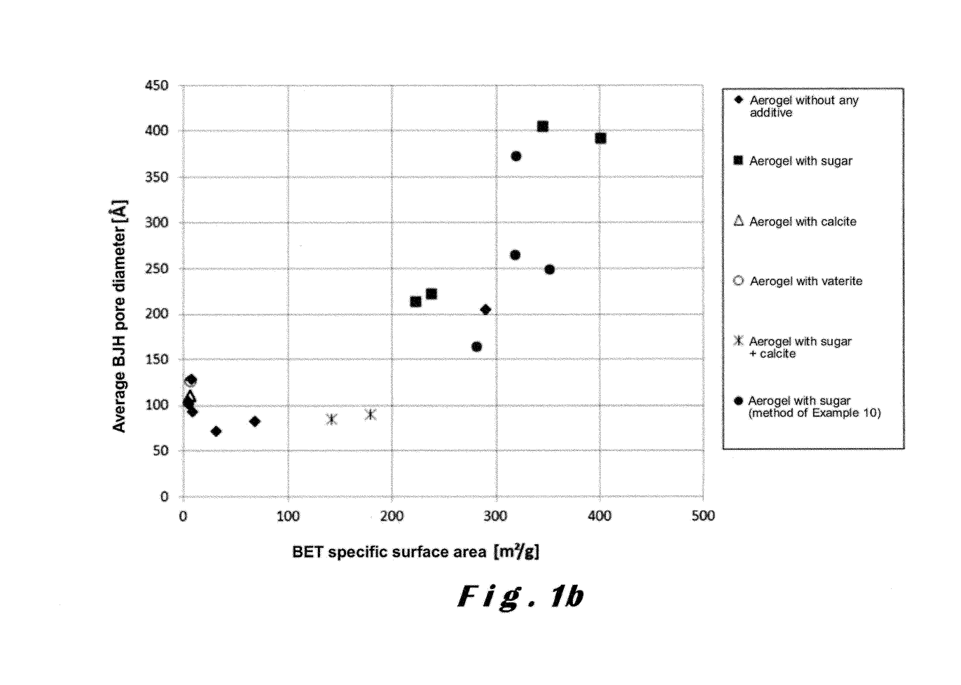

FIG. 1a illustrates the influence of the addition of additives on the BJH pore volume of aerogels obtained according to the invention.

FIG. 1b illustrates the influence of the addition of additives on the average diameter of BJH pores of aerogels obtained according to the present invention.

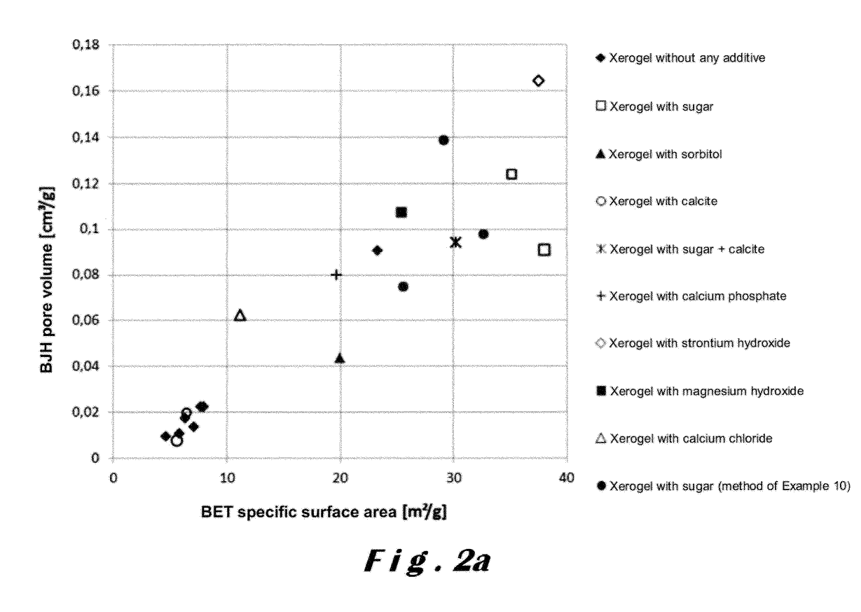

FIG. 2a illustrates the influence of the addition of additives on the BJH pore volume of aerogels obtained according to the invention.

FIG. 2b illustrates the influence of the addition of additives on the average diameter of BJH pores of aerogels obtained according to the invention.

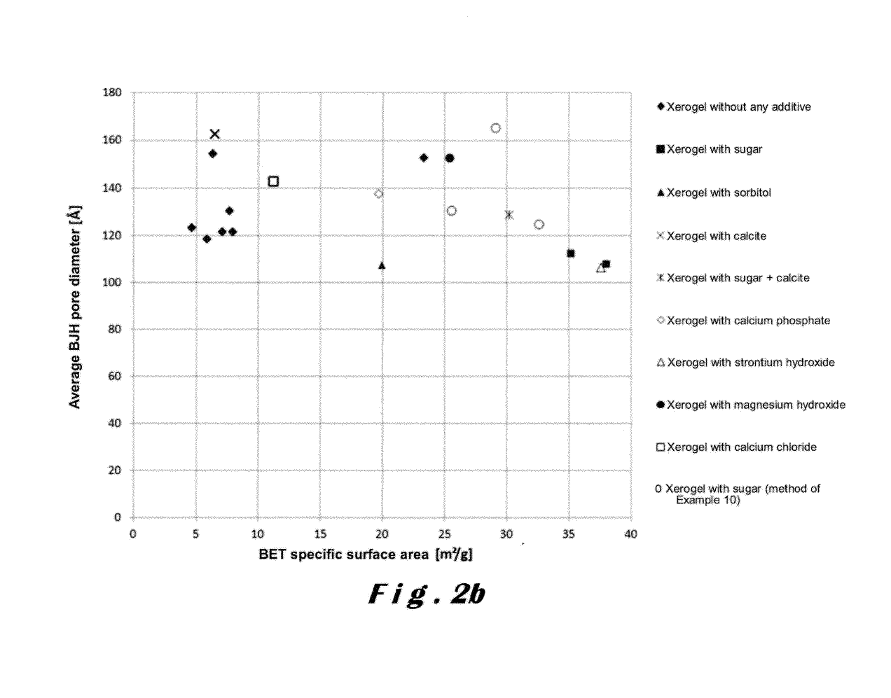

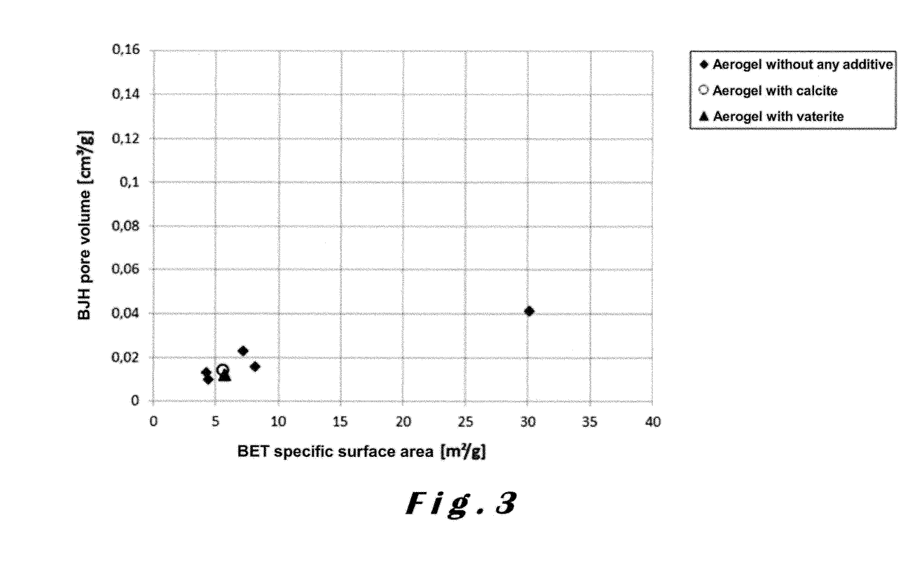

FIG. 3 illustrates the relationship between the BET specific surface area and the BJH pore volume of aerogels obtained according to the invention.

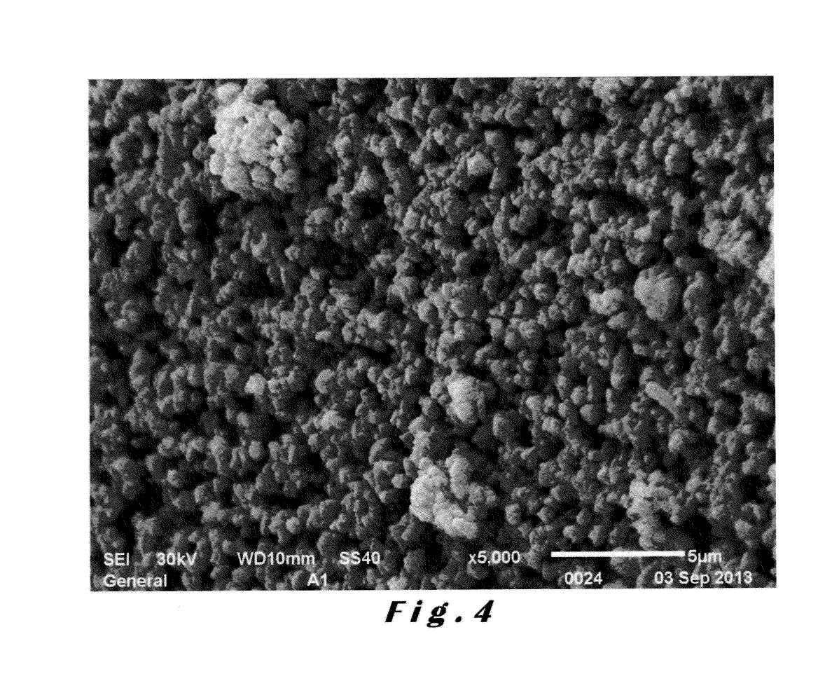

FIG. 4 illustrates an SEM image of a calcite aerogel obtained according to the invention.

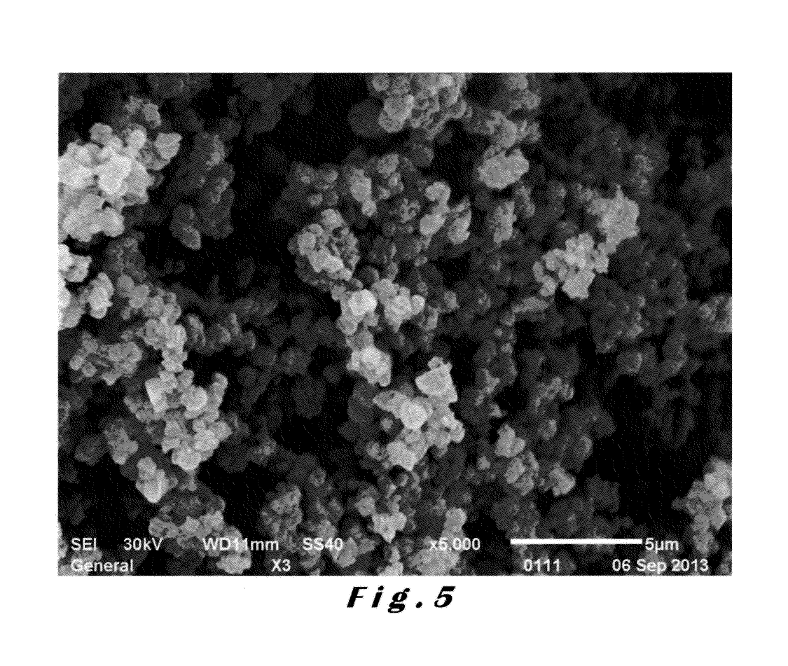

FIG. 5 illustrates an SEM image of a calcite xerogel obtained according to the invention.

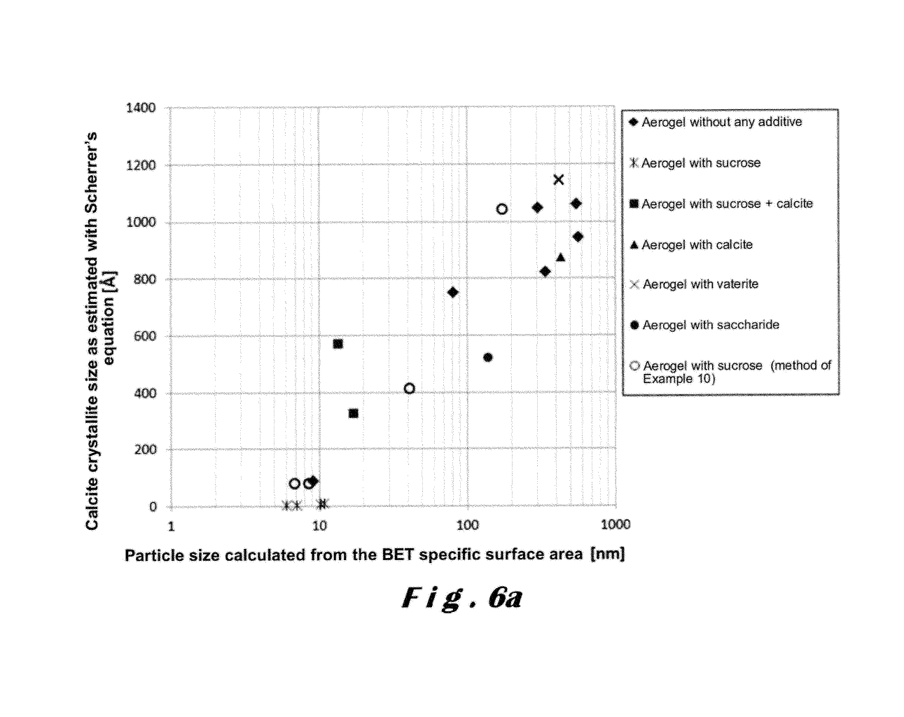

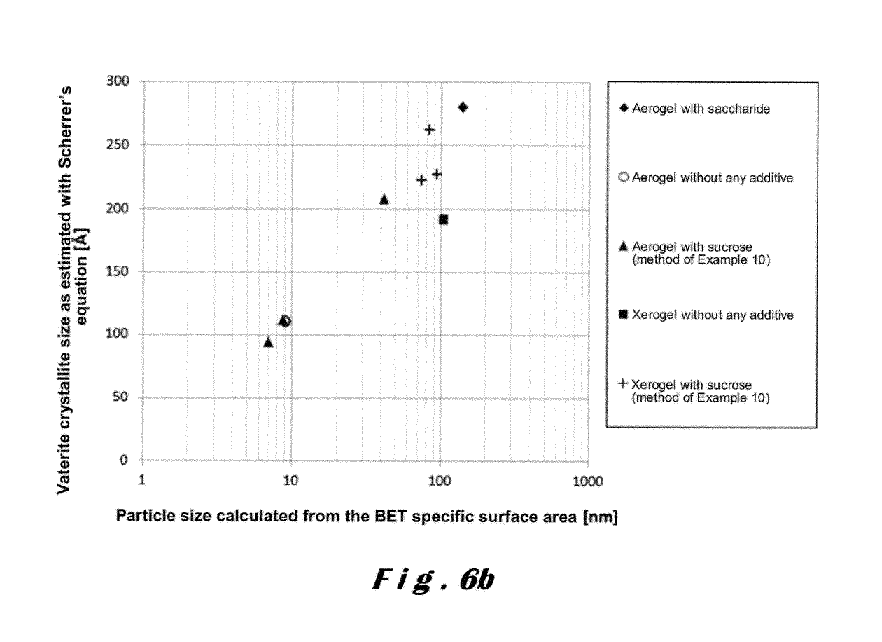

FIGS. 6a and 6b illustrate the influence of the addition of additives on the size of the crystallites and of the particles of xerogels and aerogels obtained according to the invention.

By the terms <<BJH pore volume>> in the sense of the present invention, is meant the volume of the pores for which the size is comprised between 17 and 1,000 Å (1.7 and 100 nm), measured by nitrogen desorption manometry, obtained after degassing in vacuo at 190° C., and calculated according to the BJH method.

By the terms <<average diameter of BJH pores>> in the sense of present invention, is meant the average diameter of the pores for which the size is comprised between 17 and 1,000 Å (1.7 and 100 nm), measured by nitrogen desorption manometry, obtained after degassing in vacuo at 190° C., and calculated according to the BJH method.

The carbon dioxide injection conditions influence the quality of the produced gel. Within the scope of the present invention, two different injection methods may be applied.

The first injection method uses a gas at atmospheric pressure which contains approximately 15% by volume of CO₂. In this method, a mixture of CO₂ in the presence of an inert gas may be used. Advantageously, this gas mixture has a CO₂ content comprised between 2% and 100% by volume, preferably between 4% and 50% by volume, more preferentially between 10% and 30% by volume. The gas injection is advantageously carried out under quasi-atmospheric pressure or under a low pressure, in this case at a pressure below 0.5 MPa, preferably less than 0.3 MPa.

This method gives the possibility of obtaining homogeneous and almost complete conversion of the alcoholate. It is desirable to avoid too rapid gelling in the reactor before complete conversion has taken place. In this situation, the use of a diluted gas gives the possibility of extending the injection duration and increasing the required gas volume. A diluted gas is preferred as compared to a strongly concentrated gas since, in the latter case, much higher stirring is required for obtaining sufficient homogenization of the mixture in the reactor, which increases the risk of spontaneous and uncontrollable gelling.

In the second method of the injection, described in a non-limiting way in example 10, the homogenization is increased by using pressurized liquid CO₂ while accepting spontaneous gelling. In this method, the injection of carbon dioxide is advantageously carried out until a pressure comprised between 7 and 12 MPa, preferably between 8 and 11 MPa is obtained. The use of the same reactor for carrying out the drying gives the possibility of combining the steps for carbonation of the alcoholate, for gelling and drying in the same piece of equipment. The use of liquid CO₂ gives the possibility of intensifying the conversion reaction of the alcoholate, increasing the concentration of calcium carbonate in the gel as well as the obtained density of the aerogel. It was seen that by increasing the density of an aerogel it is possible to significantly increase its mechanical strength.

In this second injection method, the steps for converting calcium hydroxide into calcium alcoholate, converting the alcoholate by injection of CO₂, gelling and drying take place in succession.

Within the scope of the present invention, x-ray diffraction (XRD) analyses allow estimation of the size of the crystallites by means of the Scherrer equation. This equation, set out below, is valid for crystallites with a size of less than 100-200 nm:

$$τ = \frac{K λ}{βcos ( θ )}$$

wherein
λ corresponds to the x-ray wavelength,
τ corresponds to the average size of the crystallite,
κ is a dimensionless factor which depends on the shape of the crystallite. Its value is typically located around 0.9.
β corresponds to the width at half-height of a peak of the diffraction pattern.

### EXAMPLE 1

### Preparation of an Alcogel

A reactor of 3 dm³ is used, having a height/diameter ratio of about 2 and equipped with a double blade stirrer, with an inlet for the gas at the bottom, and temperature, pH and conductivity sensors. This reactor has a double jacket and is made thermostatic with a heating/cooling bath.

2 dm³ of analytical grade methanol are introduced into this reactor and a temperature of 30° C. is established therein, and 75 g of commercial slaked lime are then added. The obtained suspension is mixed for 1-2 h at about 500 rpm which gives rise to the formation of a suspension of calcium methanolate in methanol. The temperature and the pH remain stable until the end of the reaction, i.e. 30° C. and respectively about 12.2 (this pH is only however obtained after 20 to 30 min of reaction). The suspension is then sieved on a sieve having a retained at 45 μm for removing the coarse particles.

The sieved suspension is then placed in a reactor into which is injected a gas mixture of carbon dioxide (15% by volume) and of technical air (85% by volume) at a flow rate of 4.75 dm³/min for 1-2 h. The injection is stopped at a pH of about 8.6, which indicates that quantitative carbonation has taken place.

The suspension is then taken from the reactor and placed in a glass beaker where it is left to gel as an alcogel of precipitated calcium carbonate, which takes about 1 h.

This alcogel is divided into two samples.

The first sample of about 1.5 dm³ is left in the beaker so as to rest therein under ambient conditions of about 18° C., with the top of the beaker covered with a plastic film. The gel remains stable, without any degradation, for about one day. X-ray diffraction (XRD) analyses of the solid material reveals that the precipitated calcium carbonate mainly consists of vaterite with small trace amounts of calcite.

### Preparation of an Aerogel

The second sample of about 50 cm³ is placed in an autoclave at room temperature and at atmospheric pressure. A thin layer of pure methanol (about 2 cm³) is added above the gel in order to protect it during the first pressurization. The autoclave is then hermetically sealed and slowly pressurized by introducing carbon dioxide until a pressure of 10 MPa is obtained, at a rate from 0.1 to 0.2 MPa/min. The introduced CO₂ has a temperature of 293 K. The autoclave is also maintained at this temperature during the first aforementioned step by thermostatization by means of a double jacket.

When the autoclave has attained 10 MPa at 293 K and is filled with liquid CO₂, the stirring starts at 150 rpm and is maintained for 20 minutes. The opening of the inlet and outlet valves for CO₂ of the autoclave then generates a continuous flow of liquid CO₂ so as to gradually replace the CO₂ mixed with methanol with pure CO₂. This operation continues for 30 minutes at a constant pressure of 10 MPa.

Next, the pressure in the autoclave is successively reduced and increased in order to accelerate extraction of the methanol:
by a slight increase in the opening level of the CO₂ outlet valve so as to achieve a very slow decrease in the pressure down to 8 MPa in approximately 15 minutes, a duration during which a continuous flow of CO₂ is maintained;
by a reduction in the opening level of the CO₂ outlet valve so as to again increase the pressure up to 10 MPa, this time again over a duration of about 15 minutes while maintaining a continuous flow of CO₂.

These successive increases and decreases of pressure are carried out until there is no longer any methanol detected at the outlet, i.e. there are no longer any methanol drops in the CO₂ expansion tank. About two hours proves to be sufficient for most of these samples (four cycles of pressure increase/reduction). When there is no longer any detected methanol, all the valves are closed but stirring is maintained.

The autoclave is then placed in a supercritical condition so as to allow draining of the CO₂ out of the autoclave in the absence of a gas/liquid interface which may damage the aerogel. To do this, the autoclave is heated up to 318 K within a period of about 20 minutes by means of the jacket. Since the temperature increases, the pressure should also increase. The pressure is however maintained constant at a value of 10 MPa by opening the outlet valve. These supercritical conditions (CO₂ at 318 K and at 10 MPa) are maintained for 30 minutes.

At the end of this period, stirring is stopped and the autoclave is then slowly brought back to ambient pressure at a rate from 0.1 to 0.4 MPa/min.

Small pieces of aerogel (powder or granules) are thereby obtained, on which is observed a BET specific surface area of about 185 m²/g (within plus or minus 10%) by analysis and, by scanning electron microscopy (SEM), a particle size of about 10 to 20 nm. These particles therefore have a high BET specific surface area to a point which could not be expected by the teaching of the state of the art. They are also clearly finer with as a consequence an increase in the density of the particles, a larger interconnection of the latter and therefore better mechanical stability of the aerogel.

### EXAMPLE 2

An alcogel is prepared as indicated in Example 1, except for the fact that the temperature in the reactor is established at 50° C. instead of 30° C. The increase in temperature causes an increase in the formation rate of the gel so that the gel is already formed in the reactor at the end of carbonation, a little after the pH has attained a value of 8.6.

### EXAMPLE 3

The preparation conditions of alcogel of Example 1 are repeated. An aerogel powder is obtained having an apparent specific gravity, observed according to the procedure described in the EN459 standard, of about 0.05 g/cm³ and a BET specific surface area of 235 m²/g (within plus or minus 10%). This suggests a size of ideal spherical particles of about 10 to 20 nm, which is confirmed by SEM images.

The aerogel sample is stored in two containers of 700 cm³ each. One of the containers is left closed, the other is opened regularly once a week. After four months, the aerogel in the closed container has reduced by 50% in volume. The aerogel in the regularly opened container has degenerated into about 100 cm³ of powder and resembles precipitated calcium carbonate (PCC) of micron size.

Furthermore, the powder from the closed container has a BET specific surface area of about 180 m²/g and a particle size of the order of 10 to 20 nm. The powder from the regularly opened container on the other hand has a BET specific surface area of only 5 m²/g and a particle size of the order of one micron, which again shows a lack of stability, probably in the presence of the humidity of the air. Actually, vaterite nanocrystals are unstable in contact with water and they recrystallize into aragonite and calcite crystals of a larger size.

### EXAMPLE 4

It is again proceeded like in the alcogel preparation of Example 1, with the difference that before proceeding with the injection of the carbon dioxide and technical air mixture, precipitated calcium carbonate in the form of calcite and having a scalenohedron morphology (PCC of filler grade for paper) and an average particle size of 2.5 μm is added to the suspension in an amount of 0.3% by weight, based on the slaked lime used.

After gelling, 50 g of a sample are taken which is subject to the aerogel preparation procedure described in Example 1. XRD analysis reveals that the calcite content has increased to 99.8% by weight and that the aerogel particles therefore totally consist of calcite. The aerogel has a BET specific surface area of only 7.6 m²/g, which corresponds to a theoretical ideal size of a spherical particle of about 290 nm. A size from 200 to about 300 nm is confirmed by observing SEM images, which show rhombohedral particles, which are strongly interconnected, having a high interparticle porosity and a high porosity between the agglomerates. This material was then stored for about eight months in ambient air without showing any sign of degradation, degeneration, or recrystallization.

### EXAMPLE 5

It is again proceeded like in the alcogel preparation of Example 1, with the difference that before proceeding with the injection of the carbon dioxide and technical air mixture, 0.3% by weight of saccharose based on the used slaked lime is added to the suspension.

After gelling, 50 g of a sample are removed, which is subject to the aerogel preparation procedure described in Example 1. The analyses reveal that the BET specific surface area of the aerogel is 415 m²/g (to within more or less 10%). This suggests an ideal spherical particle size of about 5 nm. Moreover, the analyses reveal that the average size of BJH pores has increased from 10 nm in the vaterite aerogel of Example 1 to 32 nm in the aerogel obtained in this example. By tactile pressure on the obtained aerogel, it may be realized that it attests to clearly lower brittleness than the other aerogels described in the preceding examples.

### EXAMPLE 6

An alcogel is prepared as indicated in Example 1, with the difference that before proceeding with the injection of carbon dioxide, 0.3% by weight of calcite which has a morphology of the scalenohedron type with an average particle size of calcite of 1.5 μm, and 0.3% by weight of sucrose (table sugar) based on the weight of the slaked lime are added to the suspension. The obtained gel is dried in the autoclave as explained in Example 1 in the paragraph “preparation of an aerogel”.

At the end of the method, a translucent white aerogel is obtained, having a BET specific surface area of 140 m²/g and a BJH pore volume of 1.47 cm³/g (for a pore size from 17 to 1,000 Å) and a crystallite size, estimated by means of Scherrer's equation, of 30 nm for calcite.

The size of the calcite particles, calculated from the BET specific surface area has the value of 20 nm, which is moreover confirmed by observation of the SEM images. XRD analysis reveals that the material is composed of calcite and no vaterite or aragonite particle was detected.

### EXAMPLE 7

An xerogel is prepared as indicated in Example 1. The thereby obtained gel is spread onto a Petri dish and dried in a drying oven for 8 hours at 50° C. until the gel is stable in weight. A white powder is thereby obtained and has a BET specific surface area of 23.2 m²/g, a BJH pore volume of 0.091 cm³/g (for a pore size from 17 to 1,000 Å), a crystallite size estimated by means of Scherrer's equation, of 30 nm for the calcite and 20 nm for vaterite and a particle size of 100 nm, calculated from the BET specific surface area of calcite, which is also confirmed by observing SEM images. XRD analysis reveals that the material consists in 85% by weight of vaterite and in 15% by weight of calcite.

### EXAMPLE 8

A xerogel is prepared as indicated in Example 1, with the difference that before proceeding with the injection of carbon dioxide, 0.5% by weight of calcite, which has a morphology of the scalenohedron type with an average particle size of calcite of 1.5 μm, based on the weight of the slaked lime, is added to the suspension.

The thereby obtained gel is spread onto a Petri dish and dried in a drying oven for 8 hours at 50° C. until the gel is stable in weight. A white powder is obtained which has a BET specific surface area of 5.5 m²/g, a BJH pore volume of 0.014 cm³/g (for a pore size from 17 to 1,000 Å), a crystallite size, estimated from Scherrer's equation, of 87.8 nm and a particle size of 440 nm, calculated from the BET specific surface area of the calcite, which is also confirmed by observing SEM images.

XRD analysis reveals that the material is exclusively composed of calcite.

### EXAMPLE 9

A xerogel is prepared as indicated in Example 1, with the difference that before proceeding with the injection of carbon dioxide, 0.3% by weight of calcite, which has a morphology of scalenohedron type with an average particle size of calcite of 1.5 μm, and 0.3% by weight of sucrose based on the weight of slaked lime are added to the suspension.

The thereby obtained gel is spread onto a Petri dish and dried in a drying oven for 8 hours at 50° C. until the gel is stable in weight. A grey-white granulated xerogel is obtained (similar to the aerogel obtained in Example 6) which has a BET specific surface area of 30.2 m²/g, a BJH pore volume of 0.094 cm³/g (for a pore size from 17 to 1,000 Å), a crystallite size, estimated by means of Scherrer's equation, of 29 nm for vaterite and 46 nm for calcite and a particle size of 80 nm, calculated from the BET specific surface area of the calcite, which is also confirmed by observing SEM images. XRD analysis reveals that the material consists of 55.7% by weight of vaterite and 44.3% by weight of calcite.

### EXAMPLE 10

In a 1 dm³ reactor, 0.5 dm³ of analytical methanol, 60 g of slaked lime and 0.2 g of sucrose are introduced in order to prepare a calcium carbonate aerogel. Next, the thereby obtained suspension, in the closed reactor, is mixed at 500 rpm for 2 hours at a temperature of 55° C. at atmospheric pressure. This gives the possibility of forming a suspension of calcium methanolate in methanol. Next, the temperature inside the reactor is brought to 20° C. and a liquid mixture of carbon dioxide is injected for achieving carbonation. The excess of CO₂ is removed through an outlet valve. The carbonation reaction takes pace for 2.5 hours at a pressure of 7.5 MPa. During the first half-hour, a pressure drop is observed because of the absorption of carbon dioxide (CO₂) by the alcogel. Therefore, an injection of a gas mixture of carbon dioxide is carried out several times so as to maintain the pressure of 7.5 MPa.

After one hour of reaction, the pressure spontaneously increases up to 8.5 MPa and is maintained constant until the end of the reaction which ends one hour and a half later on.

An injection of a gas mixture of carbon dioxide at a flow rate of 200 g/min is set for 4 hours at a pressure of 8.5 MPa for extracting the solvent as a mixture with liquid CO₂ via the outlet valve. The temperature is then brought to 45° C. in order to place the autoclave under a supercritical condition (CO₂ at 318 K and 8.5 MPa) so as to achieve draining of CO₂ for 45 minutes. At the end of this period, depressurization is carried out for 15 minutes at a constant temperature of 45° C.

At the end of the method, a 85 g aerogel sample is recovered out of the slaked lime suspension in methanol of 560 g which means that a yield of 15.2% by weight has been obtained.

The volume yield is comprised between 120 and 140%, given that a volume comprised between 0.6 and 0.7 dm³ has been produced from a suspension of 0.5 dm.

XRD analysis reveals that the material consist of a mixture of vaterite and calcite. The obtained aerogel has a BET specific surface area of 350 m²/g and a BJH pore volume of 2.33 cm³/g for a pore size from 17 to 1,000 Å. The crystallite size of the aerogel has the value of 8 nm, for calcite and 9 nm for vaterite, the crystallite size being estimated by means of Scherrer's equation. The aerogel has a particle size located in the same order of magnitude as that of the crystallite size. The particle size is calculated from the BET specific surface area of the calcite.

The apparent density of the aerogel has the value of 120 g/dm³ and was obtained by observing the EN 459 standard. The heat conductivity of the aerogel corresponds to 22.2 mW/m/K for a packed density of 150 g/dm³, estimated by means of a high flow rate conductometer of the Netzsch HFM 436 Lambda type. The value of 22.2 mW/m/K indicates that the obtained aerogel may be used in the field of thermal insulation.

### EXAMPLE 11

Xerogels and aerogels are prepared as indicated in the previous examples. The obtained xerogels and aerogels are characterized relatively to the BJH pore volume for pore sizes ranging from 17 to 1,000 Å and relatively to the average diameter of the pores. Both of these parameters may be measured by means of apparatuses currently used for measuring BET specific surface areas, such as the Micromeritics Tristar.

The influence of the BET specific surface area of the size of the crystallites and of the addition of additives on both aforementioned parameters was analysed.

It was seen that the surprising low density of the aerogels and xerogels comes from the fact that each of said gels consists of a lattice of particles which surround the pores. It is preferable that the apparent size of the particles observed from SEM (scanning electron microscopy) images or calculated from the BET specific surface area, is relatively small. It is also advantageous that the ratio between the size of the apparent particles and the size of the crystallites is small.

FIGS. 1a and 1b represent the influence of additives on the BJH pore volume of aerogels and on the average diameter of the BJH pores of aerogels obtained according to the invention. It was observed that by adding sucrose in the aerogels obtained according to the invention, it is possible to significantly increase their BJH pore volume (FIG. 1a) and their average diameter of BJH pores (FIG. 1b).

FIG. 1b also gives the possibility of illustrating the structural difference which exists between the aerogels having a BET specific surface area of more than 100 m²/g and those having a specific surface area of less than 100 m²/g. The latter have an average diameter of the BJH pores from about 70 to 150 Å, just like the xerogels described below. We also observe that the pore volumes of these aerogels are similar to those of the xerogels.

FIG. 2a illustrates the influence of the addition of additives on the BJH pore volume and on the average diameter of the BJH pores of the xerogels obtained according to the invention. In FIG. 2a it may be observed that the addition of additives in xerogels obtained according to the invention allows both an increase in the BJH pore volume and the BET specific surface area of these gels. On the other hand, increasing the BET specific surface area does not allow to improve the average diameter of the pores of these gels (FIG. 2b).

FIG. 3 represents the relationship between the BET specific surface area and the BJH pore volume of aerogels obtained according to the invention and having a BET specific surface area of less than 40 m²/g.

FIGS. 4 and 5 respectively illustrate SEM images of a calcite aerogel and of a calcite xerogel obtained according to the invention and having a BET specific surface area of 7.1 m²/g.

FIGS. 3 to 5 show the fact that for comparable BET specific surface areas, the xerogels and aerogels obtained according to the invention have very similar BJH pore volumes and pore sizes.

FIGS. 6a and 6b illustrate the influence of the addition of additives on the size of the crystallites and of the particles of xerogels and aerogels obtained according to the present invention. In FIG. 6a it may be observed that the size of the crystallites increases with the size of the apparent particles of the aerogels. This indicates that, when the BET specific surface area decreases, the apparent particles and the crystallite sizes increase in size.

We may also note that the increase in the crystallite sizes is more significant for calcite (FIG. 6a) than for vaterite (FIG. 6b). Consequently, if a sample contains a mixture of calcite and vaterite, the calcite crystallites will generally have a larger size.

For comparable BET specific surface areas, the xerogels and aerogels obtained according to the invention have very similar crystallite sizes.

1. A method for preparing a calcium carbonate gel, comprising
reacting a slaked lime in solid, dry form and alcohol so as to form an alcoholic suspension of calcium alcoholate,
injection of carbon dioxide into said suspension, and
gelling of the suspension as an alcogel of precipitated calcium carbonate.

2. The method according to claim 1, characterized in that the applied slaked lime is a powder having particles with a size of less than 1 mm.

3. The method according to claim 1, characterized in that the slaked lime proportion relatively to the alcohol is comprised between 15 g/dm³ and 200 g/dm³.

4. The method according to claim 1, characterized in that the carbon dioxide injection is stopped when said suspension has a pH of less than 9.

5. The method according to claim 1, characterized in that said carbon dioxide injection into said suspension takes place at a temperature comprised between 20° C. and 70° C.

6. The method according to claim 1, characterized in that it comprises, before said injection, a sieving of said suspension through a sieve having a mesh aperture comprised between 20 and 250 μm.

7. The method according to claim 1, characterized in that, before the injection and/or at the beginning of the latter, it further comprises seeding of said suspension with calcium carbonate crystals.

8. The method according to claim 7, characterized in that the seeding crystals are selected from the group consisting of calcite, aragonite, vaterite crystals and mixtures thereof.

9. The method according to claim 1, characterized in that, before the injection and/or at the beginning of the latter, it further comprises addition of at least one inhibitor of CaCO₃ crystal growth to said alcoholic suspension.

10. The method according to claim 1, characterized in that it comprises drying of the precipitated calcium carbonate alcogel, so as to form an aerogel or xerogel of calcium carbonate.

11. The method according to claim 10, characterized in that the drying of the alcogel takes place by subjecting the latter to liquid or supercritical CO₂.

12. A calcium carbonate alcogel, as obtained by a method according to claim 1.

13. The alcogel according to claim 12, characterized in that it consists of 1 to 6% by volume of precipitated calcium carbonate nanoparticles having a particle size substantially comprised between 5 and 300 nm.

14. The alcogel according to claim 13, characterized in that said nanoparticles are agglomerates of calcium carbonate crystallites.

15. The alcogel according to claim 13, characterized in that said nanoparticles are agglomerates of calcite crystallites.

16. A calcium carbonate aerogel as obtained by a method according to claim 10.

17. A calcium carbonate xerogel as obtained by the method according to claim 10.

18. The aerogel according to claim 16, characterized in that it has a BET specific surface area from 6 to 450 m²/g.

19. The aerogel according to claim 16, characterized in that it has an apparent specific gravity comprised between 0.01 and 0.15 g/cm³.

20. The aerogel according to claim 16, characterized in that it consists of an aerogel of calcite, vaterite, aragonite or mixtures thereof.

21. The aerogel according to claim 20, characterized in that it has a BET specific surface area comprised between 4 and 40 m²/g, a crystallite size comprised between 5 and 30 nm for vaterite and a particle size comprised between 60 and 600 nm.

22. The aerogel according to claim 20, characterized in that it has a BET specific surface area comprised between 100 and 450 m²/g, a crystallite size comprised between 5 and 20 nm for calcite and for vaterite and a particle size of about 10 nm when it is obtained in the presence of a growth inhibitor.

23. The xerogel according to claim 20, characterized in that it has a BET specific surface area comprised between 4 and 10 m²/g, a crystallite size comprised between 20 and 100 nm for calcite and between 15 and 30 nm for vaterite and a particle size comprised between 100 and 500 nm.

24. The xerogel according to claim 20, characterized in that it has a BET specific surface area comprised between 20 and 40 m²/g, a crystallite size comprised between 20 and 100 nm for calcite and between 15 and 30 nm for vaterite and a particle size comprised between 50 and 150 nm.

25. The xerogel according to claim 16, characterized in that it consists in an xerogel of calcite, vaterite, aragonite or mixtures thereof.

26. The xerogel according to claim 17, characterized in that it has a BET specific surface area from 6 to 450 m²/g.

27. The xerogel according to claim 17, characterized in that it has an apparent specific gravity comprised between 0.01 and 0.15 g/cm³.
